(19) United States
(12) Patent Application Publication
(10) Pub. No.: US 2026/0370661 A1
(43) Pub. Date: Nov. 19, 2026

(54) SYSTEMS AND METHODS FOR PROCESSING DATA OBJECTS IN A PROTECTED NETWORK TO BLOCK TRANSMISSION OF A SUBSET OF THE DATA OBJECTS THAT ARE SUBJECT TO NETWORK VIOLATIONS

(71) Applicant: Capital One Services, LLC, McLean, VA (US)

(72) Inventors: Alberto Purpura, McLean, VA (US); Swapnil Shinde, Ashburn, VA (US); Mohammad Sorower, Great Falls, VA (US); Emily Chen, McLean, VA (US)

(73) Assignee: Capital One Services, LLC, McLean, VA (US)

(21) Appl. No.: 19/212,565

(22) Filed: May 19, 2025

(51) Int. Cl. H04L 9/40

(52) U.S. Cl. CPC H04L 63/1416; H04L 63/1441

(57) ABSTRACT

Systems and methods are described herein that can involve obtaining a first data object to be transmitted over a protected network. The first data object can be transformed to generate a second data object. The second data object can be compared to one or more predetermined data objects. Where a match exists, the policy data object corresponding to the matching predetermined data objects can be obtained and used to further analyze the first data object and determine whether or not the first data object complies with the policy established by the policy data object(s). In some examples, where the first data object does not comply with the policy, continued transmission of the first data object within the protected network can be prevented.

### BACKGROUND

Rule-based network monitoring systems can be configured to capture traffic and inspect packet payloads and headers using text-based analysis (including regular expression matching, string searches, and so on) to detect known malicious patterns with the traffic. However, as throughput and rule complexity increase, CPU and memory burdens can increase exponentially. As a result, processing spikes risk bottlenecks or packet loss thereby impeding scalable deployment of these rule-based network monitoring systems in modern high-volume networks, leaving these networks potentially vulnerable to malicious network activity.

### SUMMARY

In view of these challenges, systems and methods are described herein relating to novel uses and/or improvements for processing data objects in a protected network to block transmission of a subset of the data objects that are subject to network violations. By integrating techniques as described herein, systems can be configured to conserve computing resources by forgoing conventional pattern matching and instead using lightweight encoders and vector databases to match the content of data objects transmitted over a network to corresponding aspects of policies controlling communication across that network. This can subsequently allow for targeted execution of machine learning models to process the content transmitted within a network in accordance with aspects of a network policy that are relevant to the content being transmitted, rather than executing brute-force approaches that can involve repeatedly invoking these models to process the content in accordance with all possible aspects of the network policy. And by generating fixed-dimensional embeddings for both incoming packet payloads and policy data objects, the systems can use efficient approximate nearest-neighbor search algorithms (for example, those involving the determination of cosine similarity) to identify relevant content matches in sublinear time and with low memory overhead, again a reduction in computing resource consumption. Only those data packets whose embeddings satisfying a predefined similarity threshold are then used for further analysis, thereby minimizing processor cycles spent on full machine learning model inference and reducing peak memory consumption compared to brute-force approaches that can involve the processing all payloads through the machine learning model.

Additionally, system accuracy can be improved by virtue of the encoder capturing semantic relationships beyond keyword spotting, and the subsequent machine learning model analysis refining the assessment using contextual, chain-of-thought reasoning. For example, the use of embeddings can allow for the matching of semantically similar packet content with policy objects (even when phrased differently), increasing true positive rates for relevant policy objects. The machine learning models described herein can then evaluate the original text in view of the matched content to determine the existence and degree of violation (if any). Together, the two-stage analysis process can allow for enhanced precision in identifying both overt and subtle infractions, such as obfuscated commands or protocol anomalies that lexical filters would miss.

In addition, networking resources can be conserved by localizing the analysis of content to be validated before transmission to other devices in a network. For example, once embeddings are generated (e.g., on a server configured as described herein), similarity comparisons can be performed using a local vector store (maintained by a database system), avoiding the need to send full packet contents across the network. Only when a candidate match is found may the system forward the original text payload to a machine learning model, thereby reducing bandwidth usage associated with conventional, brute-force approaches in distributed computing environments. This selective communication can be especially beneficial in high-throughput environments, where continuously streaming raw data for centralized analysis would otherwise saturate communication connections between devices involved in the network.

Moreover, the ability of malicious third parties to successfully evade detection or launch network-based attacks can be reduced because the embedding-based matching can resist malicious evasion tactics such as synonym replacement or packet fragmentation. Even if a malicious party alters the content of data objects to avoid filters, the encoder's latent-space representation can still align it with the corresponding policy data object. And in instances where most analysis is performed locally (e.g., at a single device), the attack surface exposed to possible attacks can be reduced, resulting in the corresponding reduction of opportunities for adversarial manipulation or data interception during transmission that may otherwise be exploited in a distributed computing environment.

To achieve these benefits, systems and methods can be implemented as described herein by configuring components of a protected network to process data objects in a protected network to block transmission of a subset of the data objects that are subject to network violations. For example, a system can include one or more processors configured to perform one or more operations. The one or more operations can include obtaining a first data object having a first data type that is transmitted over a network, the first data object associated with a request to determine a compatibility between at least one context represented by the first data object and the network. The one or more operations can include executing a transformation based on the first data object to generate a second data object having a second data type. This transformation can allow for the comparison of an encoded and more compact representation of the first data object to encoded representations of policy data objects representing a policy (or network policy), both reducing the processing and memory resources involved in comparing the two data objects (particularly in view of the above-noted brute-force approaches) to identify relevant policy data objects while capturing true semantic meanings of both that a malicious third-party may attempt to circumvent through synonym replacement, etc. In examples, the one or more operations can include matching the second data object to a set of predetermined data objects that are compatible with at least one context associated with the second data object. The one or more operations can include generating a set of composite data objects, each composite data object based on the first data object and a policy data object corresponding to the set of predetermined data objects. In some examples, the one or more operations can include determining at least one network violation based on the set of composite data objects. For example, when using a machine learning model such as a large language model, the original text represented by the first data object can be analyzed in comparison with corresponding from policy data objects to identify both overt and subtle violations of the underlying aspects of the policy represented by the policy data objects. And in instances where chain-of-thought analysis is performed, not only can a violation be identified, but also corresponding vulnerabilities that are involved. This can allow for improved control (e.g., dynamic blocking as described herein) of data objects being communicated within a network to target data objects having more severe policy violations when compared to others that have less severe violations (and, as a result, may be blocked unnecessarily, requiring additional system or network administrator review). The one or more operations can also include generating a user interface indicating at least one network violation and at least one vulnerability involved in at least one network violation. And because these operations can be performed by a single device, network resource consumption can be reduced while similarly reducing the attack surface that malicious third-parties may attempt to exploit in more distributed computing environments.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows a diagram of an environment for processing data objects in a protected network to block transmission of a subset of the data objects that are subject to network violations, in accordance with one or more embodiments.

FIG. 2 shows a diagram of a process for processing data objects in a protected network to block transmission of a subset of the data objects that are subject to network violations, in accordance with one or more embodiments.

FIG. 3 shows components for a system used to process data objects in a protected network to block transmission of a subset of the data objects that are subject to network violations, in accordance with one or more embodiments.

FIG. 4 shows a flowchart of the steps involved in a process for processing data objects in a protected network to block transmission of a subset of the data objects that are subject to network violations, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

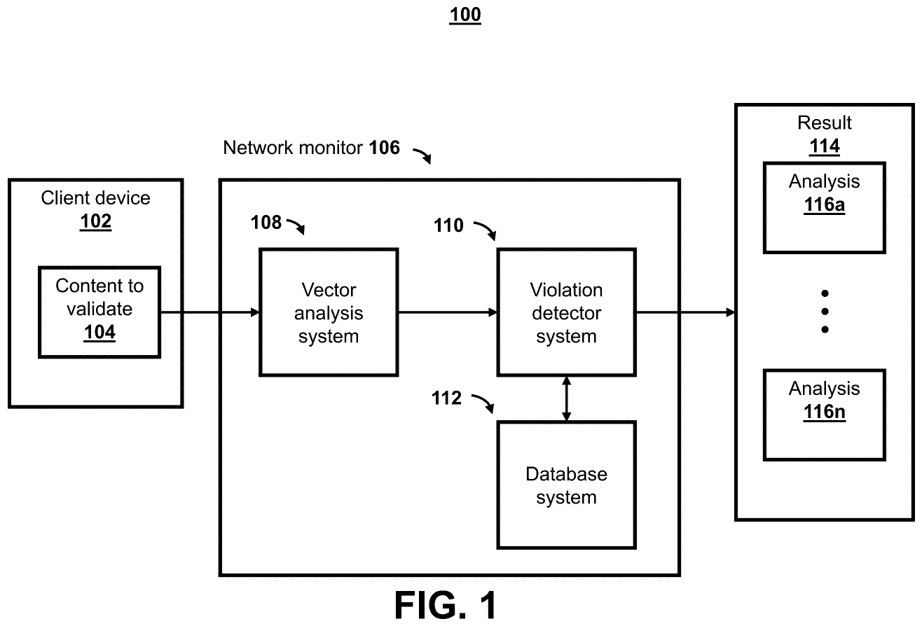

FIG. 1 shows a diagram of an environment 100 that can, among other things, be used to process data objects in a protected network to block transmission of a subset of the data objects that are subject to network violations. For example, the environment 100 can include a client device 102 and a network monitor 106 having one or more components as described herein. The client device 102 and the network monitor 106 can be configured to interconnect using one or more wired and/or wireless communication connections. As will be understood, the environment 100 includes client device 102 and a network monitor 106, but similar environments can include more devices that are the same as, or similar to, those described.

In some embodiments, the client device 102 can include a computing device that is configured to be in communication with the network monitor 106 using one or more communication paths (also referred to as communication connections) as described herein. For example, the client device 102 can include a desktop computer, a laptop computer, a smartphone, a tablet, and/or the like. As described herein, the client device 102 can establish one or more secured or unsecured communication connections with the network monitor 106 or with one or more components monitored by the network monitor 106, such as a protected network.

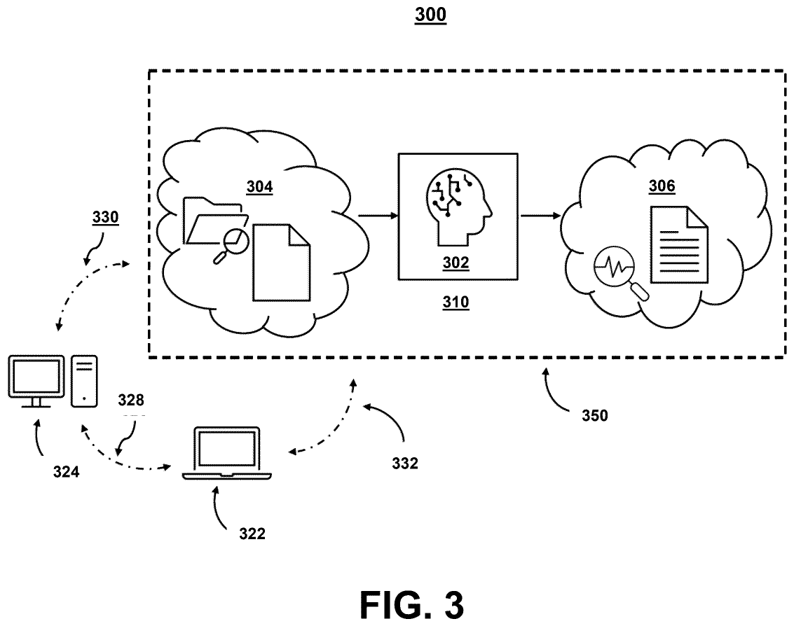

In some embodiments, the network monitor 106 can include a computing device that is configured to be in communication with the client device 102 using one or more communication connections as described herein. For example, the network monitor 106 can include a server, a desktop computer, a laptop computer, a smartphone, a tablet, and/or the like. In some embodiments, the network monitor 106 can include (e.g., implement) a vector analysis system 108, a violation detector system 110, and a database system 112. While certain components are illustrated by FIG. 1, the network monitor 106 can include and/or exclude one or more of the illustrated components. The network monitor 106 can also include one or more components that are the same as, or similar to, the user terminal 324 of FIG. 3. As described herein, the network monitor 106 (e.g., one or more components of the network monitor 106) can establish one or more secured or unsecured communication connections with the client device 102 and obtain data to be transmitted over the network by the client device 102, such as a first data object as described below. In some embodiments, the network monitor 106 can be implemented by an organization such as a financial institution monitoring a network involved in processing network operations representing transactions that may be subject to regulatory oversight, as described herein. The network monitor 106 (e.g., one or more components of the network monitor 106) can be configured to generate a result 114 including analysis 116a-116n (referred to individually and collectively as analysis 116, where contextually appropriate) indicating whether one or more network violations are represented by the first data object. In some embodiments, the network monitor 106 can be configured as an intrusion detection system, a firewall appliance, a network analyzer, etc.

In some embodiments, the vector analysis system 108 can be associated with instructions executable by the network monitor 106. For example, the vector analysis system 108 can be implemented as instructions that configure one or more components of the network monitor 106 (e.g., processor(s), memory, etc.) to perform one or more operations when analyzing data (e.g., representing the content to validate 104). The vector analysis system 108 can additionally, or alternatively, be implemented as instructions that configure one or more components of the network processor to execute one or more operations as described herein.

In some embodiments, the violation detector system 110 can be associated with instructions executable by the network monitor 106. For example, the violation detector system 110 can be implemented as instructions that configure one or more components of the network monitor 106 (e.g., processor(s), memory, etc.) to perform one or more operations when analyzing data (e.g., composite data objects representing the content to validate 104 and corresponding policy data objects). The violation detection system 110 can additionally, or alternatively, be implemented as instructions that configure one or more components of the network processor to execute one or more operations as described herein, such as dynamically blocking data transmitted by the client device 102 in response to the detection of network violation(s).

In some embodiments, the violation detector system 110 can implement (e.g., host) one or more machine learning models such as large language models configured to receive a first data object representing content with an associated context and a policy data object encoding criteria that indicate what can or cannot be transmitted across a network. For example, the violation detector system 110 can transform the composite data object (e.g., the first data object and a corresponding policy data object) into a structured input to be provided to the machine learning model. In at least some examples, the machine learning model can receive the composite data object and be configured to generate an output indicating whether a network violation exists as well as reasoning tokens that explain the vulnerability involved in the network violation (e.g., how clauses represented by the policy data object apply to the content). The machine learning model can then output a binary decision indicating whether the content violates the policy, the decision being formatted as <answer>True</answer> or <answer>False</answer> along with the indication of one or more aspects of the vulnerability.

In some embodiments, the network monitor 106 can implement a database system 112 can include a computing device that is configured to be in communication with the network monitor 106 using one or more communication connections as described herein. For example, the database system 112 can include a server, a desktop computer, a laptop computer, a smartphone, a tablet, and/or the like. In some embodiments, the database system 112 can include (e.g., implement) a database that maintains datasets including data that is associated with embeddings generated in associated with a latent space. These embeddings (referred to as predetermined data objects) can correspond to respective policy data objects.

While certain components are illustrated by FIG. 1, the environment 100, or the various devices thereof, can include and/or exclude one or more of the illustrated components. The environment 100 can also include one or more components that are the same as, or similar to, the devices of FIG. 3. In some embodiments, the devices of the environment 100 can be configured to establish direct or indirect communication connections between one another. For example, one or more networks can establish communication paths between one or more of the devices of the environment 100 to allow for the communication of messages (e.g., data packets/network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein. It will also be understood that the number and arrangement of devices in the environment 100 are provided as an example and that there can be differently arranged environments than those shown in FIG. 1. In some embodiments, at least some of the device(s) and/or system(s) of FIG. 1 can be implemented by a single device or multiple devices within a distributed system. For example, the network monitor 106 can be implemented by a single device (e.g., by the client device 102, as a stand alone computing device, etc.) or as multiple devices that, either alone or in coordination, perform one or more of the operations as described herein.

With continued reference to FIG. 1, one or more of the components of the environment 100 can be configured to execute operations that allow for the implementation of the network monitor 106 when processing data objects in a protected network. In some examples described herein, a network operation is described as being associated with and/or representing a request to execute operations and disseminate marketing materials, etc., across a network that are subject to one or more regulatory requirements established by one or more governmental agencies. However, it will be understood that the principles described herein are not limited to these types of network operations. For example, the techniques described herein can be implemented to analyze the contents of data objects transmitted over a network having any suitable context, such as commands to update entries in a database, cause the execution of operations on one or more devices of the network, etc.

In some embodiments, the network monitor 106 can obtain a first data object from the client device 102. For example, the network monitor 106 can obtain the first data object, where the first data object is associated with a request to validate content (e.g., in an electronic document, electronic file, etc. represented at least in part by the first data object). The content can be associated with one or more operations (also referred to as network operations) that, when executed within a network, cause components of the network to manage and transmit data therebetween. For example, a network operation that satisfies a policy (sometimes referred to as a network policy) as described herein can involve executing operations within a network such that content transmitted across the network complies with predefined guidelines to ensure the safe use of network resources and prevent attacks on the network (e.g., preventing the execution of operations to manipulate entries in a database (e.g., of a financial institution, etc.) in a cybersecurity attack, preventing the transmission of marketing materials that are non-compliant with the policy such as certain types of email advertisements to cardholders, text to be posted on a website in a particular state or country, content to be included in a letter or flyer, and so on). In some embodiments, a network can include networks hosting devices (e.g., computing servers, IoT devices, workstations, etc.), social networks (e.g., online communities, social media platforms, networking sites, etc.), and so on.

In some embodiments, the request can be to verify that the content satisfies the requirements of a policy controlling communication across one or more networks, such as whether the content is compatible with the requirements established for the one or more networks. This compatibility can be established based on rules according to which data is permitted to be transmitted within the network (e.g., set by a network administrator, regulatory agency, and/or combination thereof). As an example, content that does not satisfy the requirements can be the result of malicious configurations intended to attack a network (e.g., configurations that manipulate network parameters, deploy unauthorized network devices, consume computing resources, or intentionally disrupt network operations, cause the transmission of materials that intentionally misrepresent information, contain prohibited content, or fail to conform to legal standards, etc.).

In some embodiments, the vector analysis system 108 can execute (e.g., perform) a transformation based on the first data object to generate a second data object (e.g., an encoded representation of the first data object such as an embedding vector, etc.). For example, the vector analysis system 108 can use an encoder (e.g., a neural encoder, an encoder from a transformer-based neural network, a deep learning encoder, etc.) of an attention-based network (e.g., a transformer network such as a large language model (LLM), small language model (SLM), etc.) to generate the second data object representing a context of the first data object in accordance with a different data type. In some examples, the second data object can be generated by the vector analysis system 108 to generate an embedding that captures latent features using a quantified representation of the content of the first data object in a latent space.

In some embodiments, the vector analysis system 108 can be configured to determine that the context (e.g., content information, etc.) is represented by the first data object in a text format (e.g., a document represented as a set of strings of text) and/or a visual format (e.g., an image, a video, a graphical representation, etc.). The vector analysis system 108 can then determine to execute the transformation using a first encoder or a second encoder based on the context being represented in the text format (according to which the first encoder is configured) or the visual format (according to which the second encoder is configured). For example, the vector analysis system 108 can select the first encoder (e.g., a text-specific encoder, a language model (LLM) encoder, etc.) or the second encoder (e.g., an image-specific encoder, a visual model encoder, etc.) based on the context being represented in the text format or the visual format, respectively. In some examples, the second data object generated by the respective encoder can then be associated with a location in a latent space (e.g., a feature space, embedding space, etc.). Where the modality of the first encoder and the second encoder are different (e.g., where the first encoder is associated with text and the second encoder is associated with images), the latent space can be referred to as a shared latent space.

In some embodiments, the vector analysis system 108 can match the second data object to a set of predetermined data objects (e.g., encoded representations of policy data objects representing network requirements, regulatory documents, compliance texts, legal requirements, summaries thereof, etc.) that are compatible with the context associated with the second data object. For example, the vector analysis system 108 can determine cosine similarities between the second data object and the predetermined data objects in the latent space. The vector analysis system 108 can then select the predetermined data objects based on the cosine similarities and a threshold distance to identify the relevant predetermined data objects. For example, the vector analysis system 108 can select the predetermined data objects that are within the threshold distance when compared to the second data object in the latent space. This threshold distance can be represented as a scalar value according to which distances between the second data object and the predetermined data objects are compared to determine whether the threshold distance is satisfied.

In some embodiments, the vector analysis system 108 can generate a set of composite data objects. For example, the vector analysis system 108 can generate a set of composite data objects to be processed by the violation detector system 110. Each composite data object of the set of data objects can include the first data object and a policy data object (e.g., representing aspects of a policy controlling operation of a network, a regulatory document corresponding to permitted file contents that can be communicated over the network, etc.). In this example, the policy data object can be maintained in the database system 112 and mapped to corresponding predetermined data objects (e.g., embeddings for each policy data object in the latent space or shared latent space associated with the encoder(s) discussed above) that were within the threshold distance of the second data object.

In examples, a set of policy data objects can correspond to a network policy indicating criteria to be satisfied when processing data objects within the network. These criteria can represent parameters of the data objects that, when executed, result in appropriate use of the resources in the network. For example, these criteria can represent parameters related to the use of processor and memory resources within acceptable ranges (e.g., that are not indicative of malicious computing resource consumption), marketing content that complies with laws and regulations intended to protect consumers (e.g., generating offers that comply with the rules of a particular country or state, ensuring that advertising adheres to legal standards, and promoting transparent consumer practices), etc.

In some embodiments, the vector analysis system 108 can obtain a set of policy data objects based on a mapping between the predetermined data objects and the set of policy data objects. For example, the vector analysis system 108 can obtain the set of policy data objects that have the same data type as the first data object from the database system 112. The vector analysis system 108 can then determine to generate the set of composite data objects in response to obtaining the set of policy data objects when analyzing the request, wherein each composite data object includes the first data object and the policy data object corresponding to a predetermined data object. This can allow for the violation detector system 110 to provide a combined input to a machine learning model to perform a violation analysis.

In some embodiments, a policy transformation module (e.g., implemented by the network monitor 106 or a different device) can process policy data objects to generate the predetermined data objects in a manner similar to how a vector analysis system 108 processes the first data object to generate the second data object. For example, the policy transformation module can obtain a policy data object and execute a transformation to convert the policy data object into the predetermined data object. In some examples, the predetermined data object can be assigned a location in the latent space that represents a quantitative representation of the context established by the policy data object. This can allow the vector analysis system 108 to match the second data object to the predetermined data object and retrieve the corresponding policy data objects for analysis from the database system 112 of the first data object in accordance with the policy data object by the violation detector system 110 as described above.

In some embodiments, the network monitor 106 can implement the violation detector system 110 and cause the violation detector system 110 to execute one or more operations when processing and analyzing the composite data object(s). This can result in the violation detector system 110 generating a result 114 including one or more analysis 116 that can be displayed via a user interface on the client device 102 for each of the composite data objects. For example, the violation detector system 110 can determine at least one network violation (e.g., a compliance failure, a security breach, a regulation violation, etc.) based on an analysis of the set of composite data objects. To do so, the violation detector system 110 can implement and execute a machine learning model (e.g., an artificial neural network such as large language model (LLM), a small language model (SLM), etc.) to process each composite data object as an input. In response, the machine learning model can generate an output that includes a binary output (e.g., an output flag, a decision indicator, a binary signal, etc.) that indicates whether the first data object is associated with the network violation of each composite data object indicated by the corresponding policy data object. For example, the violation detector system 110 can generate a result 114 having an analysis 116 including a binary output indicating whether the marketing materials (e.g., email advertisements to cardholders, text to be posted on a website, content to be included in a letter or flyer, etc.) comply with legal requirements when compared to the policy data object. Additionally, the violation detector system 110 can generate one or more strings of text indicating certain aspects of the context (also referred to as vulnerabilities) for the first data object that resulted in the network violation(s) that are included in the analysis 116. These network violations can indicate one or more aspects of a network policy (e.g., a compliance policy, legal guideline, or regulatory standard, etc.) according to which data transmitted over the network is non-compliant.

In some embodiments, to determine at least one network violation, the violation detector system 110 can generate an input for the machine learning model (e.g., the LLM/SLM/etc.) and cause the machine learning model to execute and generate an output. For example, the violation detector system 110 can obtain and provide the composite data object as the input to cause the machine learning model to generate an output that indicates the network violation (e.g., the binary indication of whether the network violation is present, the identifier of the specific network violation that is involved, etc.). Additionally, or alternatively, the violation detector system 110 can determine a prompt (e.g., an analysis directive, an instruction string, a query prompt, etc.) based on a request, and update the composite data object to include the prompt. The prompt can be associated with the context represented by the first data object and the network. For example, the violation detector system 110 can update each composite data object to include corresponding prompts related to network resource consumption, suitability of the content of the first data object when compared to one or more regulations, etc., that address the context established by the first data object. In some examples, the composite data object can then be provided as the input to the machine learning model to allow for a reasoning-based comparison of the context of the policy data object and the context of the first data object. This can result in execution of the machine learning model to generate one or more reasoning tokens (e.g., explanation tokens, inference tokens, output tokens, etc.) that represent an analysis of aspects of the corresponding network violations.

The violation detector system 110 can determine the machine learning model from among a plurality of possible machine learning models when processing the composite data objects, where the machine learning model is configured to execute one or more attention-based operations (e.g., self-attention computations, neural attention mechanisms, transformer-based attention, etc.) and one or more reasoning operations (e.g., logical inference procedures, chain-of-thought computations, decision-making steps, etc.). For example, the violation detector system 110 can determine that the machine learning model was trained using a training dataset that is compatible with the request (e.g., have similar contexts). In this example, the violation detector system 110 can provide each composite data object as the input to the machine learning model that was selected to cause the machine learning model to generate an output.

In some embodiments, the machine learning model can be configured using a training dataset including training entries for training requests (similar to the request being processed) that are annotated to indicate the types of network violations identified and the degree to which the violations were present in the training requests. For example, each training entry can include training data objects (similar to the first data object), policy data objects, and chain-of-thought sequences (e.g., reasoning paths, inference chains, explanation sequences, etc.) that establish a set of operations mapping the training data objects and the policy data object to a target output that indicates whether a network violation was detected and/or to what degree the training request was involved in the network violation.

In some embodiments, the violation detector system 110 can determine the network violation based on the output of the machine learning model. For example, in response to receiving the composite data object as an input, the machine learning model can generate an output as described above and/or one or more reasoning tokens indicating the results of intermediate analysis performed by the machine learning model. In some examples, the violation detector system 110 can then determine the network violation and its severity by analyzing the indication of the violation and the reasoning tokens generated by the machine learning model. In some examples, the violation detector system 110 can then determine a vulnerability (e.g., system weakness, compliance vulnerability, legal risk, etc.) based on the reasoning tokens and determine to generate a user interface to indicate that vulnerability.

As noted above, the network monitor 106 can determine to generate a user interface (e.g., a dashboard, a graphical display, a web interface, etc.) that indicates the network violation and the vulnerability (e.g., compliance vulnerability, legal risk, security weak point, etc.) involved in the network violation. For example, the network monitor 106 can determine the vulnerability based on the network violation. In some examples, the network monitor 106 can determine one or more aspects of the vulnerability and generate a report that details the regulations violated along with the corresponding analysis based on the reasoning tokens. The network monitor 106 can then generate a user interface to indicate the network violation and/or the vulnerability. This user interface can include a dashboard that represents at least a portion of the result 114, such as a dashboard indicating one or more analysis 116 and their corresponding results. Additionally, the network monitor can generate or update the user interface to indicate a composite score (e.g., a score card representing an aggregated score, a risk score, a combined metric, etc.) based on the network violation. For example, the network monitor 106 can determine the composite score, where the composite score represents a value from a range of values indicating a degree of violation associated with a plurality of policy data objects being analyzed. This degree can be determined based on, for example, a configuration established by the score card, the configuration representing settings for logical regrouping of the policy data objects matched with the first data object. In some examples, the configuration established by the score card can also include settings that allow for weighting of the corresponding aspects of the policy data objects involved. In this example, the network monitor 106 can update the user interface to reflect the composite score. In some examples, the composite score provides a quantification of the degree of network violation for marketing content under review. In some examples, the network monitor 106 can then cause the user interface to be displayed on the client device 102. For example, the network monitor 106 can generate user interface data that is configured to cause a display device of the client device to display the user interface. In this example, the network monitor 106 can provide the user interface data to the client device 102, causing the user interface to be displayed.

In some embodiments, the network monitor 106 can determine to block or forgo blocking the first data object from being transmitted to one or more additional devices (e.g., communication devices, endpoint devices, network nodes, etc.) over the network. For example, the network monitor 106 can determine to block the first data object from being transmitted based on the network violation. In an example, the network monitor 106 can block the first data object when it is associated with a network violation as determined by the violation detector system 110. Additionally, or alternatively, the network monitor 106 can determine to block the first data object when it is associated with one or more scores (e.g., individual scores and/or a composite score) that satisfies a threshold value indicating that the risk associated with the continued transmission of the first data object exceeds a predetermined threshold established by the policy of the network. In some examples, the network monitor 106 can allow transmission of the first data object when no network violation is detected. Additionally, the network monitor 106 can allow transmission of the first data object when the network violation detected has a score that satisfies (e.g., is at or below) the predetermined threshold according to which violating content is permitted to be transmitted.

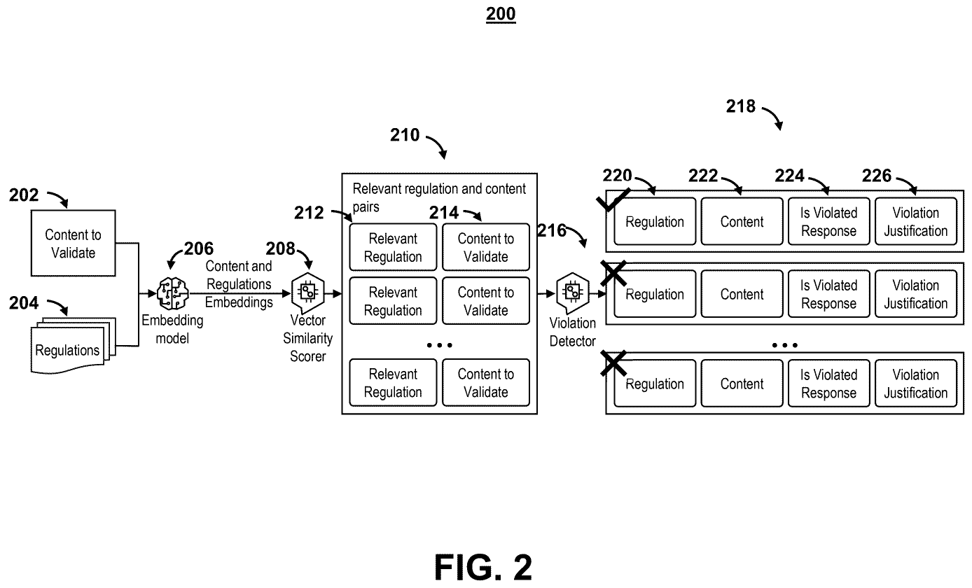

FIG. 2 shows a diagram of a process 200 for processing data objects in a protected network to block transmission of a subset of the data objects that are subject to network violations, in accordance with one or more embodiments. In some embodiments, one or more of the operations illustrated by the process 200 can be implemented using an environment (e.g., that is the same as, or similar to, the environment 100 of FIG. 1). For example, one or more of the operations illustrated by the process 200 can be implemented using a network component (e.g., that is the same as, or similar to, the network monitor 106 of FIG. 1). Additionally, or alternatively, one or more of the operations illustrated by the process 200 can be implemented by a device that is different from the network component, such as, for example, a client device (e.g., that is the same as, or similar to, the client device 102 of FIG. 1.

At 202, the process 200 can involve the network monitor obtaining content to validate from a client device 102. For example, the network monitor can receive the content as a first data object that represents potentially malicious payloads, potentially non-compliant marketing materials, and so on. In some examples, the first data object can be accompanied by metadata indicating a target audience, a jurisdiction, or a transmission priority to allow for targeted matching of relevant policy data objects to the content to validate. In some examples, the request prompting delivery of the first data object can specify that the content be checked for compatibility with network policies that govern safe use of network resources and regulate the content distributed within the network.

One objective of this “retrieval stage” can be to reduce the computational cost and execution time of the entire process 200 when compared to other techniques discussed. This can be achieved by identifying a minimal subset of relevant policy data objects (e.g., representing regulations, etc.) from a potentially extensive collection, thereby avoiding exhaustive comparisons against the entire dataset of policy data objects accessible by the network monitor. In some examples, the network monitor can leverage the same text embedding model to represent both the marketing content and regulatory texts as embeddings in a latent space and/or shared latent space. Both the content and policy data objects can be represented using multiple paragraphs. To facilitate efficient retrieval, the policy data objects can be summarized (e.g., using an LLM or based on user input) to transform the content of the policy data objects into more concise texts. In examples where the length of either the content draft to analyze or the policy data objects is larger than the context length of a machine learning model implemented by the network monitor, the context can be truncated. In examples, the machine learning models described herein can be fine-tuned with a cosine similarity loss maximizing the similarity of representations of related regulations and marketing contents. Relevance labels for each content-policy data object pair can include binary values generated with an LLM. To decide how many results to pass to the next stage of the process 200, the network monitor can determine the minimum number of policy data objects (e.g., regulations) k to return so that, on average, for example, 80% of the policy data objects list includes objects with a recall of 0.8 or higher. This value can allow the network monitor to compute the pipeline efficiency gain achieved. Given a list of n policy data objects, the process 200 efficiency gain can be measured as (n-k)/n (e.g., the number of requirements over the total that are not being processed in the second stage of the process 200 over the total. This value can be expressed as a percentage on a normalized scale (e.g., from 0-1, 1-10, etc.).

At 204, the process 200 can involve the network monitor accessing a repository (e.g., a database system) of policy data objects that establish network regulations. For example, the repository can include policy data objects indicating criteria that allow efficient use of processor and memory resources (e.g., thresholds controlling packet rates, limits on memory allocation, acceptable encryption algorithms, etc.). In some examples, the repository can also contain regulations (represented by policy data objects) intended to protect consumers by governing advertising practices (e.g., mandatory disclosures, restrictions on personal-data sharing, opt-out instructions, etc.). In some examples, each policy data object can be tagged with contextual attributes such as effective dates or regional scope to facilitate precise matching with incoming content.

At 206, the process 200 can involve the network monitor executing a machine learning model (e.g., an encoder) using a vector analysis system to transform both the first data object and the policy data objects (when constructing the repository of predetermined data objects) into latent vector representations. For example, the vector analysis system 108 can execute a transformer encoder that produces a second data object capturing semantic features of the content while maintaining context-length limits imposed by the model. In some examples, the same encoder can be applied to each policy data object to generate predetermined data objects located in a shared latent space. In some examples, the vector representations can be cached with expiration timers so that frequently referenced regulations do not impose recurring computational load.

At 208, the process 200 can involve the network monitor causing the vector analysis system to compute similarity scores between the second data object and each predetermined data object. For example, the vector analysis system 108 can determine cosine similarity values and discard any candidate regulation whose similarity value does not satisfy (e.g., falls below) a threshold distance tuned to achieve at least 0.8 recall based on historical evaluations. In some examples, the threshold distance can be dynamically adjusted when system load is high to conserve processing resources. In some examples, the similarity scores can be annotated with priority flags that reflect the severity of a potential violation or attack vector revealed by the content.

At 210, the process 200 can involve the network monitor generating composite data objects including content-policy data object pairs by selecting the closest matching predetermined data objects (identified at 208). For example, the network monitor can retain the top-k policy data objects where k is determined so that approximately eighty percent of relevant regulations are preserved while maximizing pipeline efficiency gain. In some examples, the network monitor can record the ranked-list size and the corresponding efficiency gain as telemetry for capacity-planning analytics. In some examples, each retained policy data object can be stored with its similarity score to inform later reasoning about relative importance. As a result, the network monitor can establish a set of composite data objects by combining each policy data object 212 with a corresponding first data object 202. In some embodiments, each composite data object can further include a prompt that instructs downstream systems (e.g., a violation detector system) to explain whether the content satisfies processor- and memory-efficiency criteria or violates consumer-protection rules. In some examples, the composite data objects can include version identifiers that map to specific snapshots of the policy data objects 212 to allow for confirmation of temporal consistency.

At 216, the process 200 can involve the network monitor causing a violation detector system to analyze each composite data object with a reasoning-capable machine learning model. For example, the violation detector system can generate reasoning tokens enclosed within <think> tags that reveal a chain-of-thought explaining how individual clauses of a regulation map to specific segments of the content. In some examples, the violation detector system can also output an is-violated response enclosed within <answer> tags to indicate a binary outcome that the network monitor can act upon. In some examples, reinforcement-learning fine-tuning methods such as Group Relative Policy Optimization (GRPO) can improve the machine learning model's accuracy and response-format adherence.

As discussed, following the retrieval stage, the network monitor can determine whether some content of a given request violates a given regulation and explain the reasons behind the violation. To implement this, the network monitor can implement a fine-tuned LLM that is trained to generate structured output text in the format <think>.</think><answer> (True|False)</answer>. The content between the <think>.</think> tags can represent the machine learning model's reasoning while the one enclosed between the <answer>(True|False)</answer> tags indicates whether the content violates the provided regulation (True) or not (False). An ablation study can be performed to assess whether requiring the generation of reasoning text in a response improves the performance of the machine learning model. The reward functions employed to train the machine learning model with GRPO can include the following: (i) accuracy reward (e.g., the accuracy of the model in detecting whether a content violates a regulation or not) this is equal to 1 each time the Boolean prediction in the generated text matches our ground truth and 0 otherwise; (ii) response format reward, which is equal to 1 when the response from the model matches the format <think>.*</think><answer> (True|False)</answer>, or just <answer> (True|False)</answer> when evaluating the performance of the machine learning model without reasoning tokens, and 0 otherwise; and (iii) reasoning text similarity with the ground truth. To compare the texts, the network monitor can rely on the BiLingual Evaluation Understudy (BLEU) Score. This can give a measurement of the shared word n-grams in the reasoning text generated by the model and the reasoning text available in the ground truth. The proposed reward functions can be formalized as:

r_{accuracy}={1, if prediction=ground_truth 0,otherwise} (1)

r_{format}={1, if response matches reg exp 0,otherwise} (2)

r_{reasoning}=BLEU(generated_reasoning, ground_truth_reasoning) (3)

To implement SFT, the network monitor can train the machine learning model using cross-entropy loss to compare the generated text, with and without the reasoning section depending on the experimental setting, to the ground truth response available in our training dataset.

At 218, the process 200 can involve the network monitor collecting outputs (e.g., from the violation detector system) and organizing the outputs into a structured result set (that are the same as, or similar to, result 114 of FIG. 1). For example, the result set can retain, for each evaluated pair, an identifier of the policy data object involved, the content, the is-violated response, and the reasoning tokens generated by the machine learning model. In some examples, the network monitor can tag result rows where no reasoning tokens were produced, triggering a fallback workflow that requests re-evaluation. In some examples, the result set can be exported and used by the network monitor to generate a user interface. This user interface can include a compliance dashboard that indicates violations as described herein.

At 220, the process 200 can involve the network monitor presenting an explicit reference to each regulation evaluated. For example, the network monitor can include citations such as statutory sections, policy-document titles, or internal rule identifiers to maintain a clear basis for every analysis. In some examples, the network monitor can hyperlink each regulation reference to a searchable repository so reviewers can inspect full regulatory text.

At 222, the process 200 can involve the network monitor presenting the original content segment evaluated alongside its corresponding regulation reference. For example, the content segment can be displayed with sensitive information masked according to data-privacy settings configured by an administrator. In some examples, the network monitor can highlight text spans that the violation detector system 110 flagged as potentially non-compliant or malicious.

At 224, the process 200 can involve the network monitor recording the is-violated response generated for each policy data object-content pair. For example, a “True” response can instruct the network monitor to block transmission of the first data object. In some examples, a “False” response can increment a compliance-score metric that contributes to an aggregate composite score reflected in a user-interface gauge.

At 226, the process 200 can involve the network monitor recording the violation justification produced by the machine learning model. For example, the justification can enumerate regulation clauses that are implicated and quote reasoning tokens that map content features to policy language. In some examples, the network monitor can parse the justification to extract structured entities such as prohibited phrases or excessive connection attempts so that mitigation advice can be auto-generated. In some examples, the justification text can be compared against historical violation patterns to recommend targeted remediation steps or automated content rewrites.

Process 200 is described with respect to a dataset of policy data objects being mapped to corresponding predetermined data objects. In examples, this dataset can include a collection of marketing content drafts and a collection of U.S. Advertising and Marketing legal requirements that these drafts should comply with. This dataset can allow the system to simulate real-world scenarios where machine learning models (e.g., LLMs) are employed to assist marketing teams, etc., by providing feedback on the regulatory landscape directly to such teams. To train and evaluate at the retrieval stage the network monitor can process each of the marketing content drafts under review as queries and the collection of legal regulations as documents. The objective of this can be to match content drafts with applicable legal requirements, whether these requirements are violated by the content or not will be determined by the violation detector system. The relevance labels for the query-document pairs can following a two steps process: (i) for each content draft, the network monitor can consider the top 100 most similar legal requirements relying on the vector representations provided by a base model (e.g., the all-mpnet-base-v2 model); (ii) the system can then create relevance labels for each of these pairs relying on a machine learning model such as the Llama 3.3 70B-Instruct model and the following prompt: You are an expert legal assistant working for a respected legal office, you only provide responses in JSON format. Please determine whether the provided regulation is relevant and may apply to the content discussed in the provided promotional email (True) or not (False). ###Regulation: {req} ###Email: {email}.

In the table below, performance of different variants of the proposed retrieval stage are illustrated. Considered are two machine learning models (e.g, retrieval models), all-mpnet-base-v2 and paraphrase-MiniLM-L6-v2 with supported context lengths of 384 and 128 tokens, respectively.

| | Ranked List | | Efficiency |
|---|---|---|---|
| Approach | Size (k) | Recall@k | Gain (%) |
| all-mpnet-base-v2 | 88 | 0.8726 | 80.87% |
| Fine-tuned all-mpnet-base-v2 | 50 | 0.8900 | 89.13% |
| Paraphrase-MiniLM-L6-v2 | 337 | 0.8680 | 26.74% |
| Fine-tuned paraphrase-miniLM- | 90 | 0.8974 | 80.43% |
| L6-v2 | | | |

Retrieval stage evaluation results. Given the ranked list size k and maximum ranked list size n = 460, efficiency gain is measured as (n − k)/n.

The performance of both models was evaluated before and after fine-tuning them for four epochs with a batch size of 16 and learning rate 5e-5. The performance measures that were considered are (i) the minimum ranked list size k that allows to achieve a recall higher than 0.8—e.g., that allows to retrieve at least 80% of the relevant requirements—for 80% of the content drafts; (ii) the Recall@k where k depends on the previous calculation; and (iii) the pipeline efficiency gain achieved by trimming each ranked list to the amount indicated by the first metric. These measurements allow for estimation of the impact of the retrieval component on the overall efficiency of the pipeline. As is evidenced by the results, both models benefit in a similar way from additional fine-tuning on the domain-specific data used.

Improved performance results from the larger embedding model, all-mpnet-base-v2 were observed. However, the smaller model maintains a similar relative performance also after fine-tuning, especially in terms of nDCG and the efficiency gains offered by both models more than double after fine-tuning.

In the table below, the performance results of the violation detection approach are shown.

| | Fine- | | | | | Correctly |
|---|---|---|---|---|---|---|
| | tuning | | | | | Formatted |
| Base model | Algorithm | Reward Functions | Accuracy | Precision | Recall | (%) |
| Llama 3.2 1B | SFT | — | 0.5071 | 0.5092 | 0.3909 | 98.23% |
| Instruct | | | | | | |
| Llama 3.2 3B | SFT | — | 0.5319 | 0.5489 | 0.3574 | 99.51% |
| Instruct | | | | | | |
| Llama 3.2 1B | GRPO | Format, Accuracy | 0.4913 | 0.4942 | 0.7428 | 87.37% |
| Instruct | | | | | | |
| Llama 3.2 3B | GRPO | Format, Accuracy | 0.5103 | 0.5148 | 0.3601 | 81.39% |
| Instruct | | | | | | |

Violation detection stage evaluation results on LLMs that do not generate any reasoning tokens. Accuracy, Precision
and Recall have been computed considering the performance over the entire test dataset (micro-averaged).

| | Fine- | | | | | | Correctly |
|---|---|---|---|---|---|---|---|
| Base | tuning | Reward | | | | BLEU | Formatted |
| model | Algorithm | Functions | Accuracy | Precision | Recall | Score | (%) |
| Llama 3.2 | SFT (R) | — | 0.4877 | 0.4892 | 0.5601 | 0.0285 | 14.31% |
| 1B Instruct | | | | | | | |
| Llama 3.2 | SFT (R) | — | 0.5220 | 0.5341 | 0.3449 | 0.0629 | 37.25% |
| 3B Instruct | | | | | | | |
| Llama 3.2 | GRPO (R) | Format, Accuracy | 0.4957 | 0.4944 | 0.3748 | 0.0000 | 99.15% |
| 1B Instruct | GRPO (R) | Format, BLEU, | 0.4936 | 0.4909 | 0.3453 | 0.0000 | 98.95% |
| | GRPO (R) | Accuracy | 0.5016 | 0.5009 | 0.9208 | 0.0008 | 97.73% |
| | | Format, BLEU | | | | | |
| Llama 3.2 | GRPO (R) | Format, Accuracy | 0.5471 | 0.5612 | 0.4320 | 0.0104 | 98.37% |
| 3B Instruct | GRPO (R) | Format, BLEU, | 0.6110 | 0.5881 | 0.7411 | 0.0400 | 97.96% |
| | GRPO (R) | Accuracy | 0.6651 | 0.6435 | 0.7401 | 0.0802 | 94.53% |
| | | Format, BLEU | | | | | |

Violation detection stage evaluation results of reasoning LLMs. Accuracy, Precision, and Recall have been computed considering the performance over the entire test dataset (micro-averaged).

The Llama3.2 1B-Instruct and Llama3.2 3B-Instruction models were fine tuned in accordance with the techniques discussed above. Performance was evaluated using this approach, considering the problem as a binary classification task, in terms of Accuracy, Micro-Averaged Precision, Micro-Averaged Recall, BLEU Score and percentage of correctly formatted responses.

For what concerns the BLEU Score, this measure was used to estimate the similarity between the reasoning text generated by the fine-tuned model and the reasoning text in our ground truth computed using Llama 3.3 70B-Instruct. The percentage of correctly formatted responses was computed using either of the following regular expressions, depending on whether the approach was supposed to generate any reasoning tokens or not: \hat{ }<think>.*</think><answer> (True|False)</answer>$ or just its second part after the </think> tag. The regular expression matches text spans that begin with the <think> tag, contain any type of character until the closing </think> tag is met, followed by the <answer> and </answer> tags surrounding either the text “True” or “False”. This structured output format allows for the responses from the models to be parsed and to reliably evaluate their performance. As indicated herein, the evaluation dataset is balanced like the training set, e.g., it contains the same number of pairs of violated content draft-legal requirement pairs. Another important consideration on our training and test datasets is that the content draft seen by the models during training are different from the ones used in the test dataset—while the legal requirements may overlap, as in a real-world use scenario. This allows for a more accurate estimate of the generalization ability of the models we fine-tune.

FIG. 3 shows illustrative components for a system used to process data objects in a protected network to block transmission of a subset of the data objects that are subject to network violations, in accordance with one or more embodiments. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 can alternatively be any computing device as described above and can include any type of mobile terminal, fixed terminal, or other device. For example, cloud components 310 can be implemented as a cloud computing system and can feature one or more component devices. It should also be noted that system 300 is not limited to three devices. Users can, for instance, utilize one or more devices to interact with one another, one or more servers, or other components of system 300. It should be noted that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays and can instead receive and display content using another device (e.g., a dedicated display device such as a computer screen and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storage. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communications networks or combinations of communications networks. Communication paths 328, 330, and 332 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, an artificial intelligence model, etc. (which can be referred to collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem-solving as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, backpropagation techniques can be utilized by model 302, where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) cannot perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively, or additionally, the API layer 350 can reside on one or more of the cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications is in place.

In some embodiments, the system architecture can use a microservice approach. Such systems can use two types of layers: Front-End Layer and Back-End Layer, where microservices reside. In this kind of architecture, the role of the API layer 350 can provide integration between the Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as a standard for external integration.

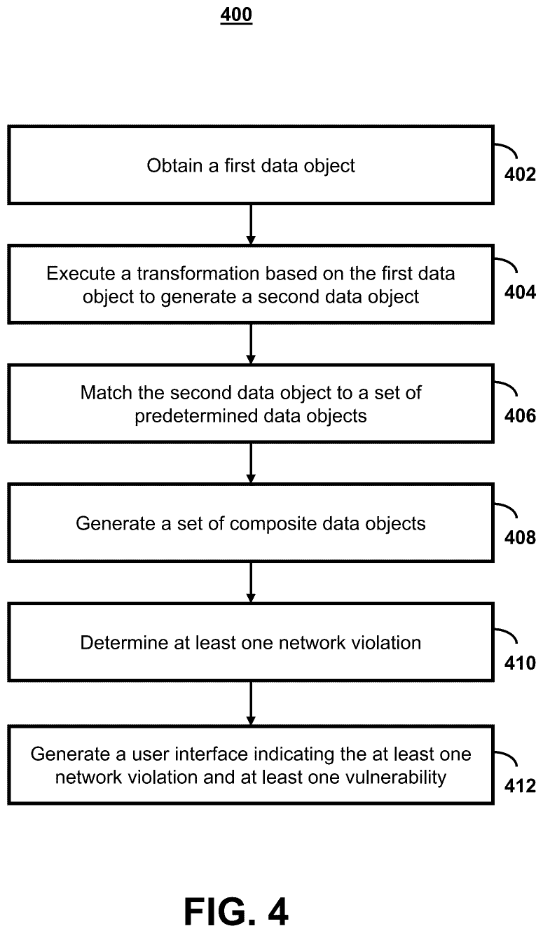

FIG. 4 shows a flowchart of the steps involved in a process 400 for processing data objects in a protected network to block transmission of a subset of the data objects that are subject to network violations, in accordance with one or more embodiments. For example, a system that is the same as (or similar to) the network monitor 106 of FIG. 1 (or one or more components thereof) can implement process 400.

At operation 402, the process 400 can include obtaining a first data object. For example, a network monitor can obtain the first data object from a client device that is configured to communicate with other devices over a protected network. The network monitor can obtain the first data object, where the first data object represents content to validate such as potentially malicious payloads (e.g., scripts attempting to probe firewall rules, phishing messages embedded in HTML, executables designed to exfiltrate data, etc.), marketing materials (e.g., email advertisements to cardholders, text intended for publication on a regional website, content to be included in a direct-mail flyer, etc.) and/or the like. The request can specify compatibility checks against network policies that govern safe use of network resources and impose limits on parameters commonly exploited during attacks such as excessive connection attempts associated with distributed-denial-of-service traffic.

At operation 404, the process 400 can include executing a transformation based on the first data object to generate a second data object. For example, the network monitor can implement a vector analysis system to execute an encoder of an attention-based network such as a transformer to produce an embedding that captures semantic features of the content while normalizing input length through truncation. In some examples, the vector analysis system can reuse the same encoder to transform policy data objects to be stored in a database system accessible by the network monitor, thereby representing both content and policy data objects in a shared latent space that preserves semantic relationships.

At operation 406, the process 400 can include matching the second data object to a set of predetermined data objects stored in the database system. For example, the vector analysis system can compute cosine similarity values between the second data object and each predetermined data object and can select those predetermined data objects whose similarity values satisfy a threshold distance. In some examples, similarity calculations can be accompanied by priority scores for each policy data object that reflect estimated risk levels. In examples, the threshold distance can be dynamically adjusted (e.g., increased or decreased) based on network traffic volumes (e.g., in relation to corresponding increases and decreases in network traffic) to balance detection performance against computational overhead.

At operation 408, the process 400 can include generating a set of composite data objects that each concatenate the first data object with a corresponding predetermined data object selected at operation 406. The composite data objects can then be analyzed using a violation detector system to determine whether a violation exists, and to what degree the violation exists.

At operation 410, the process 400 can include determining at least one network violation by providing each composite data object to a reasoning-capable machine learning model hosted by a violation detector system. For example, the violation detector system can generate reasoning tokens enclosed within <think> tags that explain how specific portions of a policy data object (e.g., representing clauses of a regulation, etc.) relate to features of the content and can output an is-violated response enclosed within <answer> tags indicating whether the content violates the policy data object. Additionally, or alternatively, the violation detector system can generate a score indicating a degree to which the first data object violates one or more aspects established by the policy data object.

At operation 412, the process 400 can include generating a user interface indicating at least one network violation and at least one vulnerability determined during operation 410. For example, the network monitor can construct a dashboard that lists each evaluated policy data object alongside the corresponding content segment, the is-violated response, and a violation justification derived from reasoning tokens so that reviewers obtain transparent, auditable insight. In some examples, the user interface can present a composite score that quantifies the severity of detected violations on a continuous scale and can include interactive controls enabling reviewers to request contextual sentence expansion or remediation suggestions. In these examples, the network monitor can block transmission of content associated with True violations while allowing compliant content to proceed, thereby conserving network bandwidth and processor resources and mitigating exposure to malicious or non-compliant transmissions.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Some or all of the systems described herein can be implemented by configuring one or more Application-Specific Integrated Circuit (ASICs). As described, an ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects that can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for processing data objects in a protected network to block transmission of a subset of the data objects that are subject to network violations.
2. The method of any one of the preceding embodiments, comprising: obtaining a first data object having a first data type that is transmitted over a network, the first data object associated with a request to determine a compatibility between at least one context represented by the first data object and the network; executing a transformation based on the first data object to generate a second data object having a second data type; matching the second data object to a set of predetermined data objects that are compatible with at least one context associated with the second data object; generating a set of composite data objects, each composite data object based on the first data object and a policy data object corresponding to the set of predetermined data objects; determining at least one network violation based on the set of composite data objects; and generating a user interface indicating at least one network violation and at least one vulnerability involved in at least one network violation.
3. The method of any one of the preceding embodiments, wherein executing the transformation comprises: determining that at least one context is represented in a text format or a visual format; and determining to execute the transformation based on at least one context being represented in the text format or the visual format.
4. The method of any one of the preceding embodiments, further comprising: selecting a first encoder or a second encoder based on at least one context being represented in the text format or the visual format; wherein executing the transformation comprises: determining to execute the first encoder or the second encoder based on the first data object to generate the second data object, where the second data object is assigned a location in a latent space associated with the first encoder and the second encoder.
5. The method of any one of the preceding embodiments, wherein matching the second data object to the set of predetermined data objects that are compatible with at least one context associated with the second data object comprises: determining cosine similarities between the second data object and predetermined data objects that are associated with a latent space; and selecting the set of predetermined data objects based on the cosine similarities and a threshold distance.
6. The method of any one of the preceding embodiments, further comprising: obtaining a set of policy data objects based on a mapping between the predetermined data objects and the set of policy data objects, the set of policy data objects having the first data type; and determining to generate the set of composite data objects in response to obtaining the set of policy data objects, each composite data object of the set of composite data objects comprising the first data object and the policy data object corresponding to a predetermined data object from the set of predetermined data objects.
7. The method of any one of the preceding embodiments, wherein determining at least one network violation based on the set of composite data objects comprises: for each composite data object of the set of composite data objects, generating an input for a machine learning model; and providing the input to the machine learning model to cause the machine learning model to generate an output indicating at least one network violation.
8. The method of any one of the preceding embodiments, wherein providing each composite data object as the input to the machine learning model comprises: determining a prompt based on the request, the prompt associated with at least one context represented by the first data type and the network; and updating each composite data object to comprise the prompt, the first data object and the predetermined data object.
9. The method of any one of the preceding embodiments, wherein providing each composite data object as the input to the machine learning model comprises: determining the machine learning model that is configured to execute one or more attention-based operations and one or more reasoning operations from among a plurality of machine learning models configured to analyze the data objects to be processed in the network; and determining to provide each composite data object as the input to cause the machine learning model to generate the output indicating at least one network violation.
10. The method of any one of the preceding embodiments, wherein the machine learning model is configured using a training dataset comprising training entries, each training entry comprising training data objects, policy data objects, and chain-of-thought sequences establishing a set of operations mapping the training dataset and the policy data object to a target output.
11. The method of any one of the preceding embodiments, wherein causing the machine learning model to generate the output indicating at least one network violation comprises: determining the machine learning model from among a plurality of machine learning models based on at least one context; and causing execution the machine learning model to generate one or more reasoning tokens representing corresponding network violations.
12. The method of any one of the preceding embodiments, wherein determining at least one network violation comprises: obtaining the one or more reasoning tokens in response to execution of the machine learning model; and determining at least one network violation based on the one or more reasoning tokens generated by the machine learning model.
13. The method of any one of the preceding embodiments, further comprising: generating a binary output indicating whether the first data object is associated with at least one network violation based on at least one network violation; and determining to generate the user interface indicating at least one network violation and at least one vulnerability involved in at least one network violation based on the binary output.
14. The method of any one of the preceding embodiments, wherein generating the user interface indicating at least one network violation and at least one vulnerability involved in at least one network violation comprises: determining at least one vulnerability based on at least one network violation; and determining one or more aspects of at least one vulnerability based on at least one network violation, wherein generating the user interface comprises: generating the user interface to indicate the one or more aspects of at least one vulnerability.
15. The method of any one of the preceding embodiments, further comprising: providing a composite data object comprising a prompt, the first data object, and a predetermined data object from the set of predetermined data objects as an input to a machine learning model, the composite data object configured to cause the machine learning model to execute one or more attention-based operations and one or more reasoning operations to generate one or more reasoning tokens; determining at least one vulnerability based on the one or more reasoning tokens; and in response to determining at least one vulnerability based on the one or more reasoning tokens, determining to generate the user interface to indicate at least one vulnerability.
16. The method of any one of the preceding embodiments, further comprising: generating a composite score based on at least one network violation, the composite score representing a value from a range of values indicating a degree of violation; and updating the user interface to represent the composite score.
17. One or more non-transitory, computer-readable mediums storing instructions recorded thereon that, when executed by a data processing apparatus, cause the data processing apparatus to perform operations comprising those of any of embodiments 1-16.
18. A system comprising one or more processors and memory storing instructions that, when executed by the processors, cause the processors to effectuate operations comprising those of any of embodiments 1-16.
19. A system comprising means for performing any of embodiments 1-16.

What is claimed is:

1. A system for processing data objects in a protected network to block transmission of a subset of the data objects that are subject to network violations, the system comprising:
one or more processors; and
one or more non-transitory computer-readable mediums having instructions recorded thereon that, when executed by the one or more processors, cause the one or more processors to perform operations comprising:
obtaining a first data object having a first data type that is transmitted over a network, the first data object associated with a request to determine a compatibility between at least one context represented by the first data object and the network;
executing a transformation based on the first data object to generate a second data object having a second data type;
matching the second data object to a set of predetermined data objects that are compatible with the at least one context associated with the second data object;
generating a set of composite data objects, each composite data object based on the first data object and a predetermined data object from the set of predetermined data objects, the set of predetermined data objects corresponding to a network policy indicating criteria to be satisfied when processing the data objects in the network;
determining at least one network violation based on the set of composite data objects, at least one network violation indicating one or more aspects of the network policy that are satisfied by the first data object;
generating a user interface indicating the at least one network violation and at least one vulnerability involved in the at least one network violation; and
blocking the first data object from being transmitted to one or more devices over the network based on the at least one network violation.

2. A method for processing data objects in a protected network to block transmission of a subset of the data objects that are subject to network violations, the method comprising:
obtaining a first data object having a first data type that is transmitted over a network, the first data object associated with a request to determine a compatibility between at least one context represented by the first data object and the network;
executing a transformation based on the first data object to generate a second data object having a second data type;
matching the second data object to a set of predetermined data objects that are compatible with at least one context associated with the second data object;
generating a set of composite data objects, each composite data object based on the first data object and a policy data object corresponding to the set of predetermined data objects;
determining at least one network violation based on the set of composite data objects; and
generating a user interface indicating the at least one network violation and at least one vulnerability involved in the at least one network violation.

3. The method of claim 2, wherein executing the transformation comprises:
determining that the at least one context is represented in a text format or a visual format; and
determining to execute the transformation based on at least one context being represented in the text format or the visual format.

4. The method of claim 3, further comprising:
selecting a first encoder or a second encoder based on the at least one context being represented in the text format or the visual format;
wherein executing the transformation comprises:
determining to execute the first encoder or the second encoder based on the first data object to generate the second data object, where the second data object is assigned a location in a latent space associated with the first encoder and the second encoder.

5. The method of claim 3, wherein matching the second data object to the set of predetermined data objects that are compatible with the at least one context associated with the second data object comprises:
determining cosine similarities between the second data object and predetermined data objects that are associated with a latent space; and
selecting the set of predetermined data objects based on the cosine similarities and a threshold distance.

6. The method of claim 5, further comprising:
obtaining a set of policy data objects based on a mapping between the predetermined data objects and the set of policy data objects, the set of policy data objects having the first data type; and
determining to generate the set of composite data objects in response to obtaining the set of policy data objects, each composite data object of the set of composite data objects comprising the first data object and the policy data object corresponding to a predetermined data object from the set of predetermined data objects.

7. The method of claim 6, wherein determining the at least one network violation based on the set of composite data objects comprises:
for each composite data object of the set of composite data objects, generating an input for a machine learning model; and
providing the input to the machine learning model to cause the machine learning model to generate an output indicating the at least one network violation.

8. The method of claim 7, wherein providing each composite data object as the input to the machine learning model comprises:
determining a prompt based on the request, the prompt associated with the at least one context represented by the first data type and the network; and
updating each composite data object to comprise the prompt, the first data object and the predetermined data object.

9. The method of claim 7, wherein providing each composite data object as the input to the machine learning model comprises:
determining the machine learning model that is configured to execute one or more attention-based operations and one or more reasoning operations from among a plurality of machine learning models configured to analyze the data objects to be processed in the network; and
determining to provide each composite data object as the input to cause the machine learning model to generate the output indicating the at least one network violation.

10. The method of claim 9, wherein the machine learning model is configured using a training dataset comprising training entries, each training entry comprising training data objects, policy data objects, and chain-of-thought sequences establishing a set of operations mapping the training dataset and the policy data object to a target output.

11. The method of claim 9, wherein causing the machine learning model to generate the output indicating the at least one network violation comprises:
determining the machine learning model from among the plurality of machine learning models based on the at least one context; and
causing execution of the machine learning model to generate one or more reasoning tokens representing corresponding network violations.

12. The method of claim 11, wherein determining the at least one network violation comprises:
obtaining the one or more reasoning tokens in response to execution of the machine learning model; and
determining the at least one network violation based on the one or more reasoning tokens generated by the machine learning model.

13. The method of claim 2, further comprising:
generating a binary output indicating whether the first data object is associated with the at least one network violation based on the at least one network violation; and
determining to generate the user interface indicating the at least one network violation and the at least one vulnerability involved in the at least one network violation based on the binary output.

14. The method of claim 2, wherein generating the user interface indicating the at least one network violation and the at least one vulnerability involved in the at least one network violation comprises:
determining the at least one vulnerability based on the at least one network violation; and
determining one or more aspects of the at least one vulnerability based on the at least one network violation,
wherein generating the user interface comprises:
generating the user interface to indicate the one or more aspects of the at least one vulnerability.

15. The method of claim 2, further comprising:
providing a composite data object comprising a prompt, the first data object, and a predetermined data object from the set of predetermined data objects as an input to a machine learning model, the composite data object configured to cause the machine learning model to execute one or more attention-based operations and one or more reasoning operations to generate one or more reasoning tokens;
determining the at least one vulnerability based on the one or more reasoning tokens; and
in response to determining the at least one vulnerability based on the one or more reasoning tokens, determining to generate the user interface to indicate the at least one vulnerability.

16. The method of claim 2, further comprising:
generating a composite score based on the at least one network violation, the composite score representing a value from a range of values indicating a degree of violation; and
updating the user interface to represent the composite score.

17. One or more non-transitory computer-readable mediums storing instructions thereon that, when executed by one or more processors, cause the one or more processors to:
obtain a first data object having a first data type that is transmitted over a network, the first data object associated with a request to determine a compatibility between at least one context represented by the first data object and the network;
execute a transformation based on the first data object to generate a second data object having a second data type;
match the second data object to a set of predetermined data objects that are compatible with the at least one context associated with the second data object;
generate a set of composite data objects, each composite data object comprising the first data object and a policy data object corresponding to the set of predetermined data objects;
determine at least one network violation based on the set of composite data objects; and
generate a user interface indicating the at least one network violation and at least one vulnerability involved in the at least one network violation.

18. The one or more non-transitory computer-readable mediums of claim 17, wherein executing the transformation comprises:
determining that the at least one context is represented in a text format or a visual format; and
executing the transformation based on the at least one context being represented in the text format or the visual format.

19. The one or more non-transitory computer-readable mediums of claim 18, further comprising:
selecting a first encoder or a second encoder based on the at least one context being represented in the text format or the visual format;
wherein executing the transformation comprises:
executing the first encoder or the second encoder based on the first data object to generate the second data object, where the second data object is assigned a location in a latent space associated with the first encoder and the second encoder.

20. The one or more non-transitory computer-readable mediums of claim 18, wherein matching the second data object to the set of predetermined data objects that are compatible with the at least one context associated with the second data object comprises:
determining cosine similarities between the second data object and predetermined data objects that are associated with a latent space; and
selecting the set of predetermined data objects based on the cosine similarities and a threshold distance.
